(19) United States
(12) Patent Application Publication
(10) Pub. No.: US 2023/0376594 A1
(43) Pub. Date: Nov. 23, 2023

(54) SYSTEMS AND METHODS FOR IDENTIFYING RANSOMWARE ACTORS IN DIGITAL CURRENCY NETWORKS

(71) Applicant: The Trustees of Columbia University in the City of New York, New York, NY (US)

(72) Inventors: Siddhartha Dalal, Somerset, NJ (US); Zihe Wang, Long Island City, NY (US); Siddhanth Sabharwal, Fremont, CA (US)

(21) Appl. No.: 18/197,134

(22) Filed: May 15, 2023

Related U.S. Application Data
(60) Provisional application No. 63/344,784, filed on May 23, 2022.

(51) Int. Cl. G06F 21/56; G06F 21/55; G06Q 20/02

(52) U.S. Cl. CPC G06F 21/565; G06F 21/552; G06Q 20/02

(57) ABSTRACT

Disclosed are methods, systems, and other implementations, including a method for identifying and predicting illegal digital currency transactions that includes obtaining one or more blockchains of transaction blocks for transactions involving digital currency, deriving from the one or more blockchains of transaction blocks a transaction graph of sequential transactions, and applying clustering processing to the transaction graph to generate resultant one or more entity graphs representative of likely chains of digital currency transfers by respective one or more entities. The method further includes extracting graph feature data from the resultant one or more entity graphs, and applying classification processing (e.g., supervised learning classification processing) to the extracted graph feature data to identify a suspected malicious entity from the one or more entities associated with the one or more entity graphs.

### CROSS-REFERENCE TO RELATED APPLICATIONS

This application claims the benefit of, and priority to, U.S. Provisional Application No. 63/344,784, entitled “Systems and Methods for Identifying Ransomware Actors in Digital Currency Networks,” and filed May 23, 2022, the content of which is incorporated herein by reference in its entirety.

### BACKGROUND

Ransomware is a class of malicious software that, when installed on a computer, prevents a user from accessing the computer (usually through unbreakable encryption) until a ransom is paid to the attacker. In this type of attack, cybercriminals profit from the value victims assign to their locked data and their willingness to pay a fee to regain access to them. Bitcoin is a popular cryptocurrency used by ransomware actors to get ransom as it shields a person's personal identity by allowing them to transact using a Bitcoin address. Further, a bitcoin account holder (i.e., an actor) can create and hide behind multiple bitcoin addresses on the fly. Many fraudulent actors exploit this Bitcoin's pseudo-anonymity for their nefarious purposes. Prominent recent ransomware examples are Locky, SamSam, or WannaCry. It has been reported that the latter ransomware example infected up to 300,000 victims in 150 countries and that the lower bound estimate of the amount of bitcoin involved in ransomware transactions between 2013 to 2017 was more than 22,967.94 bitcoins amounting to over a billion dollars at an exchange rate of 1 BTC=$46, 491.11 (in February 2021).

### SUMMARY

Disclosed are implementations (including hardware, software, and hybrid hardware/software implementations) directed to a framework to identify potential malicious activity involving digital currency (such as ransomware activities in which a malicious actor extorts cryptocurrency ransom payments, e.g., in the form of bitcoin, from victims). The proposed framework addresses the question of, given temporally limited graphs of Bitcoin (or other digital currency) transactions, to what extent can one identify common patterns associated with these fraudulent activities and apply them to find other ransomware actors. The problem is rather complex, given that thousands of addresses can belong to the same actor without any obvious links between them and any common pattern of behavior. Contributions of the solutions proposed herein include introducing and applying new processes for local clustering and supervised graph machine learning to identify patterns associated with ransom transactions (when represented by transaction graph, or through graphs derived from transaction graphs such as actor-to-actor graphs) and to identify malicious actors. Experimentation and evaluation of the proposed framework showed that very local subgraphs of the known such actors are sufficient to differentiate between ransomware, random, and gambling actors with 85% prediction accuracy on the test data set.

Thus, in some variations, a method for identifying illegal digital currency transactions is provided. The method includes obtaining one or more blockchains of transaction blocks for transactions involving the digital currency, deriving from the one or more blockchains of transaction blocks a transaction graph of sequential transactions, applying clustering processing to the transaction graph to generate resultant one or more entity graphs representative of likely chains of digital currency transfers by respective one or more entities, extracting graph feature data based on the resultant one or more entity graphs, and applying classification processing to the extracted graph feature data to identify a suspected malicious entity from the one or more entities associated with the one or more entity graphs.

Embodiments of the method may include at least some of the features described in the present disclosure, including one or more of the following features.

Applying the classification processing may include applying a machine learning classification process to the extracted graph feature data to determine the suspected malicious entity.

Applying the classification processing may include applying a machine learning classification process to data derived based on the one or more entity graphs. The machine learning classification process may be trained using initial address data comprising one or more digital currency addresses associated with one or more rogue transactions.

Applying the machine learning classification process may include applying an ensemble of independent classification processes to the data derived based on the one or more entity graphs to separately determine, by the independent classification processes, respective classifications for one of the one or more entities, and determining a composite classification for the one or more entities based on the separate classifications determined by the independent classification processes.

The transaction graph may include one or more starting nodes corresponding to the one or more digital currency addresses.

Extracting graph feature data may include determining from the one or more entity graphs one or more subgraphs, and computing for a subgraph, from the one or more determined subgraphs, one or more graph centralities, including one or more of, for example, number of graph vertices, number of graph edges, total value of digital currency corresponding to the graph, number of graph loops, graph degree, graph neighborhood size, normalized closeness for one or more nodes of the graph, betweenness measure for the one or more nodes of the graph, a Page rank measure for the one or more nodes, cluster measure for the one or more nodes, coreness measure for the one or more nodes, and/or hub and authority measure for the one or more nodes.

Determining the one or more subgraphs comprises determining at least one of, for example, an ego graph and/or a simple graph.

The transaction graph may include transaction nodes in which a first transaction node specifies an output address associated with a second transaction node to which the first transaction node is connected.

Applying clustering processing to the transaction graph may include applying the clustering processing to local areas of the transaction graph.

Applying clustering processing to the transaction graph may include applying localized and/or temporal clustering processing to form clusters according to set of rules applied to input and output addresses of each transaction node in the transaction graph.

Deriving the transaction graph of sequential transactions may include identifying a particular address associated with a particular transaction, and generating a restricted transaction graph from the transaction graph that extends n transaction blocks upstream and downstream from the identified particular transaction with the identified particular address.

The method may further include removing transaction blocks from the restricted transaction graph that are determined to be associated with addresses of gambling or exchange sites.

In some variations, a system to identify illegal digital currency transactions is provided. The system includes one or more memory devices to store processor-executable instructions and data, and a processor-based controller coupled to the one or more memory devices. The processor-based controller is configured, when executing the processor-executable instructions, to obtain one or more blockchains of transaction blocks for transactions involving digital currency, derive from the one or more blockchains of transaction blocks a transaction graph of sequential transactions, apply clustering processing to the transaction graph to generate resultant one or more entity graphs representative of likely chains of digital currency transfers by respective one or more entities, extract graph feature data based on the resultant one or more entity graphs, and apply classification processing to the extracted graph feature data to identify a suspected malicious entity from the one or more entities associated with the one or more entity graphs.

In some variations, a non-transitory computer readable media is provided that includes computer instructions executable on a processor-based device to obtain one or more blockchains of transaction blocks for transactions involving digital currency, derive from the one or more blockchains of transaction blocks a transaction graph of sequential transactions, apply clustering processing to the transaction graph to generate resultant one or more entity graphs representative of likely chains of digital currency transfers by respective one or more entities, extract graph feature data based on the resultant one or more entity graphs, and apply classification processing to the extracted graph feature data to identify a suspected malicious entity from the one or more entities associated with the one or more entity graphs.

Embodiments of the system and the computer readable media may include at least some of the features described in the present disclosure, including at least some of the features described above in relation to the method.

Other features and advantages of the invention are apparent from the following description, and from the claims.

### BRIEF DESCRIPTION OF THE DRAWINGS

These and other aspects will now be described in detail with reference to the following drawings.

FIG. 1 is a block diagram depicting an overall pipeline of a framework for identifying rogue actors associated with fraudulent transactions.

FIG. 2 is a diagram of an example transaction graph.

FIG. 3 is a sample of an example directed transaction graph.

FIG. 4 includes boxen plots showing the number of vertices and edges in the whole-simple Actor-to-Actor graphs.

FIG. 5 includes boxen plots for Page-Rank results obtained for three address classes.

FIG. 6 includes boxen plots for a weighted-IN closeness of ego-1 simple graphs.

FIG. 7 includes boxen plots of the coreness parameter normalized by the number of vertices.

FIG. 8 includes boxen plots of the unweighted cluster coefficient, in the normal scale.

FIG. 9 is a diagram of a classifier stacking model with six different base classifiers used for creating a classification ensemble.

FIG. 10 is a diagram of a stacking-bagging classification model.

FIG. 11 is a flowchart of an example procedure for identifying illegal digital currency transactions.

FIG. 12 includes a graph and table showing feature importance for an Ego-1-simple graph.

FIG. 13 includes performance tables, including one showing the balanced accuracy of different implemented classifiers for various graphs.

FIG. 14 includes a table showing the final classifier model accuracy, precision and recall, and the corresponding confusion matrix of the test data.

Like reference symbols in the various drawings indicate like elements.

### DESCRIPTION

Disclosed are implementations (including hardware, software, and hybrid hardware/software implementations) directed to a framework to identify fraudulent actors in a digital currency network (e.g., Bitcoin network) through graph classification. This is done by collecting data from multiple public sources on known ransomware addresses reported by their victims. These are used to generate connected transaction graphs in a limited time window. Since an actor (i.e., an account holder) can have many addresses, bitcoin addresses belonging to the same actor are identified through a proposed local clustering solution. The framework derives features from subgraphs of Actor-to-Transaction bipartite graphs and identifies other suspect ransomware actors using supervised machine learning. Testing and evaluation of implementations described herein showed that the proposed framework can successfully distinguish ransomware and gambling actors from random accounts with high accuracy.

The technology described herein implements a process for clustering transactions and a machine learning process (model) for differentiating between malicious transactions, gambling transactions, and normal bitcoin transactions. Addresses are clustered together if multiple addresses pay into the same transaction or if there is only one change of address, while addresses identified as being a result of a CoinJoin transaction are ignored (in some embodiments, a process to identify CoinJoin based on multiple criteria can be developed). The set of processes implemented had an accuracy of 85% on the test dataset. As such, this technology may be useful in identifying malicious actors and preventing future ransomware attacks.

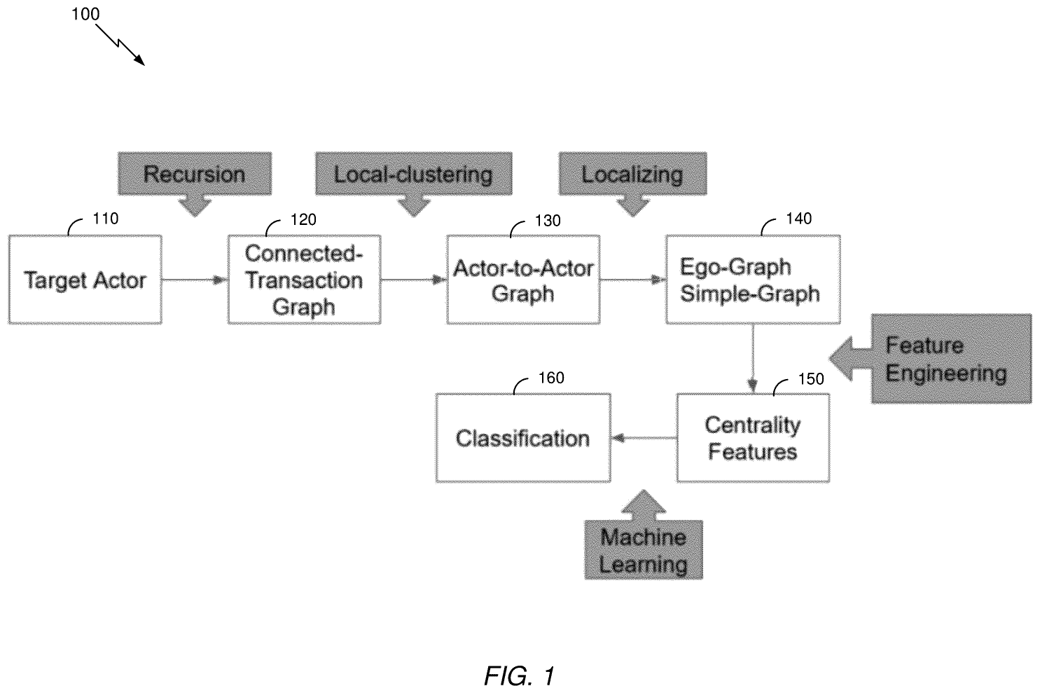

With reference to FIG. 1, a block diagram depicting an overall pipeline of a framework 100 for identifying rogue actors associated with fraudulent transactions is shown. The first stage of the pipeline of the framework 100 includes the collection of the data to be analyzed (e.g., transactions data and address data that includes addresses tagged as being associated with a ransomware transaction), as represented by block 110 (target actor block). The proposed framework needs to first be trained to identify, or classify, transactions and/or addresses, as being in a ransomware class or as being in the “random” and “gambling” classes. For the implementations described herein two key sources of data were used. First, a source(s) that had addresses tagged as being associated with ransomware (i.e., for the “ransomware” class). Second, a source(s) that had a comparison set of addresses that were not associated with ransomware, i.e., for the “random” and “gambling” classes. The random and gambling addresses are used as a comparison group for supervised machine learning. Before analyzing the transaction pattern of the addresses collected, transaction data (e.g., for Bitcoin transactions) is retrieved, processed, and analyzed. For example, during testing and evaluation of the implementations of the proposed framework, Bitcoin transaction were downloaded from the Bitcoin Blockchain using Bitcoin Core, and the raw data files containing the validated transactions were then accessed. The binary raw data was converted to a more human accessible format for analysis using BlockSci, which is an in-memory analytical database that allows for fast exploration over blocks and transactions due to their sequential, append-only generation process. This data thus provided access to the entire transaction history for all addresses being analyzed.

The first data source type included a database of addresses of known ransomware actors. People who have been victims or approached for ransom often publish the bitcoin address where bitcoins were asked to be sent as ransomware. Bitcoin WhosWho and Bitcoin Abuse are two example sites where user-submitted addresses are maintained. Aside from the above-mentioned data source types, information can be collected from previously published literature and law enforcement published actions (e.g., SEC). Wallet Explorer is an example of the second type of data source. It is a website that allows users to view the blocks and the individual transactions inside that block. From there one can also view the addresses and amounts involved in the transaction. The gambling addresses that were collected in the course of implementing the framework described herein were all of the Bitcoin addresses that have sent or received money from any of the associated gambling websites like CoinGaming, PocketDice, and BitcoinPokerTables but are not directly tagged to those websites. These websites are primarily designed so users can gamble using Bitcoin. However, they sometimes have the added consequence of allowing money laundering to occur as users can “clean” their stolen Bitcoin into cash. Transactions associated with these gambling addresses are referred to as the “Gambling” class transactions.

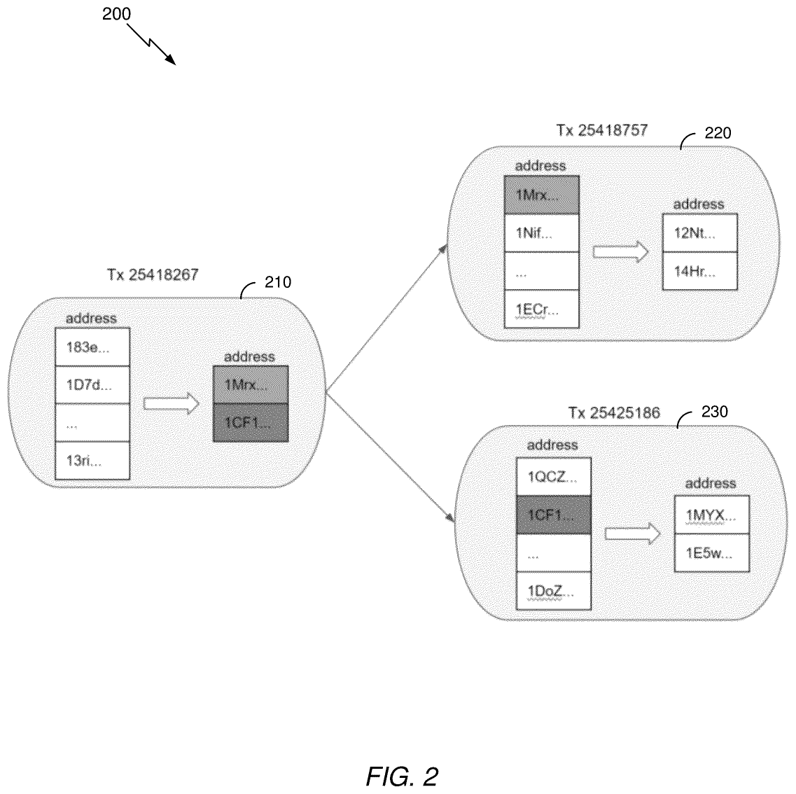

As further depicted in FIG. 1, the second stage of the pipeline involves the derivation of transaction graphs, as performed by Connected Transaction Graph module 120. Bitcoin, for example, has three primary connected components: transactions, addresses and bitcoin transferred. From these, transactions-address bipartite graph can be created. Transactions are arranged in a set of sequentially linked blocks generated randomly approximately every 10 minutes (around 144 blocks per day). Each transaction has a set of input addresses, a set of output addresses and the amount of bitcoins transferred between them. There is also a transaction fee paid to the miner (an address that created the block). However, there is no input for the Coinbase transactions, which are algorithmic transfers of bitcoins, one in each block to the corresponding miner. In the simplest terms, the transaction graph includes a directed acyclic graph (dag), T, A, W, with transactions in the set T represented as nodes, input to output addresses in the set A represented as directed edges between transactions, and the bitcoin transferred in the set W represented as edge weights. Except for the transactions in the first block (the so-called genesis block) and Coinbase transactions, each transaction node is connected to multiple previous transactions as input nodes. A transaction node might not have an output node at a given time since there may be no transactions utilizing the output addresses of that transaction as input address at the given time. A directed edge from node X to node Y means that an output address in X was an input address in Y and spent all of the Bitcoin they received in X in Y. FIG. 2 is a diagram of a transaction graph 200 connecting a first transaction represented as left node 210 to two downstream transactions represented as nodes 220 and 230.

The transaction graph for a bitcoin transaction starts from a genesis block, and ends at the last block being considered. Interesting information captured by the graph includes the behavior of an entity represented by a given address with the hope of identifying common patterns. Given an actor A, the derivation of the graph is used to identify the first transaction T_{A} involving that actor, and iteratively identifying the transactions Tₚ feeding to T_{A} and transactions T_{f} being fed by it. This defines children-parents relationship. This process is followed by iteratively taking transitive closure of all the children and parent transactions of Tₚ and T_{f} in the set of all transactions T. Though this limits the cardinality of the newly formed transaction set T_{A} corresponding to an address A, the beginning of the chain can still reach the genesis block or Coinbase transactions.

Because rogue ransomware actors tend to make, upon receiving a ransom payment, multiple successive transactions in an effort to evade detection, the derivation process of the transaction graph can be simplified. For example, graphs generated focus on temporally local behavior of the address at a distance of ±n blocks. Specifically, to define the local behavior, the following three (3) rules were used in the embodiments tested:
1. Given a first transaction in T_{A} with an address A under consideration, let the set T_{A,n} represent all the transactions in blocks ±n distance away from the block containing the first transaction. For example, if the first transaction, T₁ was in block 10,000 then the set T_{A,n} represents all the transactions between blocks 10,000±n.
2. Further restrict T_{A,n} when the output side is an address belonging to an exchange or gambling business (as identified, for example, by Wallet Explorer or some other information source or service). This is done because the children transactions links of the exchange node have many actors that have nothing to do with each other.
3. As an exception to the stopping criterion 1, a Coinbase transaction is not (and cannot be) tracked backward.

Other restrictions or conditions to simplify the construction of transaction graphs may also be applied. For example, in some embodiments, in addition to the above three rules, the set T_{A,n} was further restricted as follows:
Non-standard Scripts—There were several cases that Blocksci or various other explorers could not parse the address and would return a NaN, which can result in a situation that the output of source transaction or the input of the destination transaction or both are NaN. In this situation, in order to prevent the loss of information, dummy addresses were created to replace the NaN, unless an explorer could be found that could parse the script. In that case the correct address was manually inserted.
Proof of Burn—OpReturn transactions, where an address may burn bitcoin to save a data item on the blockchain, were assigned a string ‘burn’ to replace the NaN.
CoinJoin Transactions—For the Actor-to-Actor graph creation, mixing CoinJoin transactions should be identified. Rules used by BlockSci were modified, in some implementations, to tag CoinJoin transactions with the following rules:
   If the transaction has less than 2 input or 3 output addresses, it is not a CoinJoin.
   If the number of input addresses is smaller than half of the number of the output addresses, the transaction is not a CoinJoin.
   If the number of the output addresses is less than 6 and all output amounts are equal, the transaction is considered a CoinJoin.
   If the number of the output addresses is more than 6, the transaction is considered CoinJoin if at least 5 output amounts are equal.

In summary, T_{A,n} is the connected subgraph of the first transaction involving the actor A within n blocks on either side of the transaction, subject to the exceptions/restrictions described above (or based on some other restrictions, constraints, or criteria). To build the weighted transaction graphs, each of the edge of the transaction graph had a weight corresponding to the transacted bitcoins. This required the information on the amount of input and output bitcoins and transaction fees in each transaction, so as to maintain the equilibrium of Input_amount=output_amount+transaction fees.

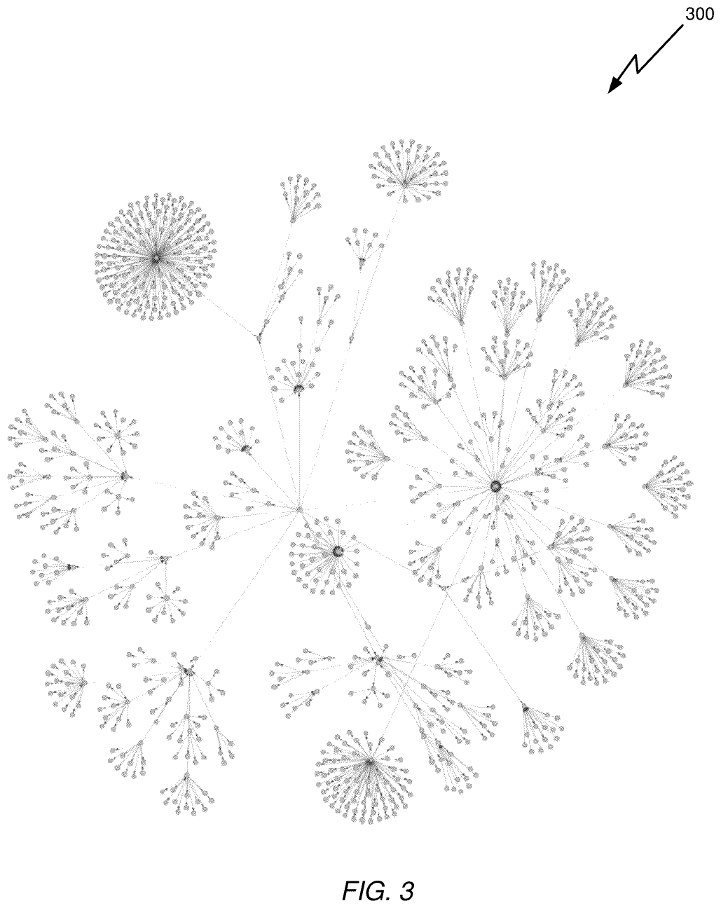

As an illustrative example of a graphical representation of a directed transaction graph, consider FIG. 3 which shows a sample of directed transaction graph 300 for a transaction set T_{A,n} emanating from the Actor “12HaVrpXkLr2UnkM f 6X 9b” on both sides. For ease of viewing, all the self-loops have been removed, multiple edges have been collapsed, and no weights are shown in the figure.

Having generated the transaction graph, the next stage is to perform local clustering and derive actor-to-actor graphs, performed by Actor-to-Actor block 130 of FIG. 1. Since it is the behavior of an actor that is of interest, an actor-to-actor graph is required rather than an address-to-address graph. There are several difficulties with generating actor-to-actor graphs. The main one lies with identification of the set of all addresses used by an actor. This is mainly due to the fact, as noted above, that bitcoin network allows an account holder (i.e., an actor) to create multiple bitcoin addresses on the fly. For simplicity, the set of all addresses owned by an actor is referred to as an entity set, and the corresponding graph is referred to as an “entity graph” or an “Actor-to-Actor” graph.

As is widely accepted, many address clustering schemes are imperfect, and ground truths are difficult to obtain on a large scale since it requires interacting with service providers. Many other heuristics are possible, including those that account for the behavior of specific wallets. In an experiment to test implementation of the present framework data going back to July 2019 was used. When applying such heuristics to the entire blockchain, one super cluster was produced containing more than 90% of addresses. This is primarily due to tumblers (the services which mix bitcoins) and CoinJoin kinds of transactions where multiple parties combine their transactions to preserve their anonymity. This is compounded by misattribution of the change of address.

Several modifications to the basic logic of behavioral clustering are considered. However, when applied globally all of them have exceptions which results in a large number of false unions resulting in large clusters due to transitive closures. To limit potential for wrong clusters that get propagated across the entire bitcoin blockchain, a different strategy was developed for creating local clusters since the objective was mainly to identify scam artists who try to move bitcoin in a short period of time soon after starting their ransomware related scam. Just like any other crime, ransomware artists move ransomware payments as quickly as possible. Thus, it was decided to apply the clustering process(es) earlier only locally within the temporal limit of n blocks—in some embodiments n was selected to be ±144 blocks; basically within ±1 day.

There are various schemes and processes that can be used to generate useful actor-to-actor graphs. An example embodiment of one such scheme is based on the following rules:
1. Inputs spent to the same transaction are controlled by the same actor, thus, the entity set is the union of all those addresses.
2. If there is only one change address, identified by it never being used prior to the current transaction (i.e., it is a new address), it is considered as a part of the input address set.
3. Exceptions to the rules 1 and 2 are when a transaction is identified as CoinJoin. In that case the union operation is not performed.
   Generally, address clustering schemes such as those described above are used within a given local cluster (e.g., they are applied to local areas of the transaction graph). This is because a global application of such clustering schemes can produce a large number of false positives, resulting in clusters containing millions of addresses. It should also be noted that the above clustering scheme may be used in conjunction with processes to identify CoinJoin transactions. Without such CoinJoin identification processes, the address clustering processes may also result in a large number of false positives.

An example pseudo-code to implement a clustering process based on the above example rules is provided below:

Generate Local Cluster Process

```
for all transactions in the graph do
  if this is a CoinJoin transaction then
    assign each input and output addresses as separate clusters.
  else
    if there is only one new address in output addresses of this transaction
  assign all input addresses and output addresses as one cluster.
    else
      assign all input addresses as one cluster;
      assign each input and output addresses as separate clusters.
    end if
  end if
end for
```

After collected all address-cluster mapping, merge the mapping and iterate until there is only one cluster for each address.

For the weighted graph analysis, the bitcoin transfer between addresses needs to be determined. Since the bitcoin transfer is defined between the sets of input addresses and output addresses, there is no exact way to allocate the amount between a given input address and an output address unless one of the sets has cardinality 1. Thus, in some embodiments, the transfer can be approximated by a proportional allocation rule. Namely, given a transaction with input addresses I₁, . . . , Iₓ; input amounts IA₁, . . . , IAₓ; output addresses O₁, . . . , O_{y}; and output amounts OA₁, . . . , OA_{y}, the edge weight from Iᵢ to Oⱼ is computed by the following formula (IAᵢ/ΣIAₖ)*OAⱼ, which is further adjusted by the transaction fee. This is an approximation, but the approximation is quite good since the total input to the transaction equals the output plus the transaction fees. For Actor-to-Actor graphs, the weights are the sum of all individual weights of the corresponding addresses.

The development described so far allows to form Actor-to-Actor weighted graphs. Some of these graphs, after clustering, had only a small number of nodes and were deleted. These were further sub-divided for supervised learning into training and test sets of, e.g., 328 and 82 graphs, corresponding to 80-20% allocation, respectively.

As noted, this is just one example clustering processes, and many other clustering processes to generate actor-to-actor graphs may be used instead.

Following generation of the actor-to-actor graph(s), the next stage is to extract graph feature data from the resultant actor-to-actor (entity) graph(s). The resultant features derived from the actor-to-actor graph include subgraph features, derived, for example, using the Ego-Graph and Ego-Simple-Graph (also referred to as “Simple-Graph” in short) block 140 of the pipeline of the framework 100 of FIG. 1, and centrality features derived, for example, through the centrality features block 150 of the framework 100 of FIG. 1.

Consider first the subgraph features that are derived from the actor-to-actor graph. Recall that a locally clustered Actor-to-Actor graph is associated with a connected transaction graph T_{A,1} for an actor A within ±144 blocks (±1 day). The subgraph of all addresses within T_{A,1} is referred to simply as whole graph. For additional analysis, several different kinds of subgraphs are taken. Specifically, since the primary interest lies in the actor under consideration, Ego subgraphs are created for the actor. Ego graph of order n of a node is the subgraph formed by the nodes that are within the neighborhood of order n of the node without considering the direction of the edges. Ego graphs are richer than standard motifs since they also consider relationships between neighbors. Another set of subgraphs, called simple graphs are obtained by removing loops of the nodes to itself, and collapsing multiple edges to one edge. These subgraphs are considered since it is expected that the actor's footprints would be most visible in its direct transaction with other nearby actors. For example, the ransomware actor's footprints would be most visible in its interactions with the victims and other nearby actors and co-conspirators. For further analysis, in some embodiments, only ego1, ego2, ego3, which are corresponding versions of simple graphs, may be considered.

As noted, the block 150 of the pipeline of the framework 100 determines centrality features based, in part, on the subgraphs that were determined (by the block 140) from actor-to-actor graph(s) generated by the block 130. For example, in some embodiments, for each of the resultant graphs (or subgraphs derived therefrom), a number of graph-based features can be extracted, including:
i. Basic Statistics: # of Vertices, # of Edges, Total bitcoins, Loops, Degree, Neighborhood size;
ii. Centralities: Normalized Closeness, Betweenness, Page Rank, Cluster Coefficient, Coreness, Hub and Authority

The above are just some of the possible features that may be computed from resultant actor-to-actor graphs (or sub-graphs derived from actor-to-actor graphs). Some of the above parameters are overall graph parameters, with the rest being restricted to the node of the actor under consideration. A number of variants of these were considered where it made sense including weighted, unweighted and directed. In one example embodiment implementation of the proposed framework described herein, the creation of graph and extraction were all carried out by using Python igraph library.

The task of computing graphs and its features is computationally intensive. For efficiency reasons, during testing an evaluation of the implementations of the proposed framework graphs larger than one million unique addresses, or more than ½ million transactions, were not considered. Whole graphs with only a small number of nodes and the corresponding ego graphs were also removed. Finally, to better balance the classes, a random sample of size 155 was taken from random graphs. An 80-20 split between training and test data with stratification resulted in the training set of 328 whole graphs (124 random, 80 ransom, 124 gambling), and the test set of 82 whole graphs (31 random, 20 ransom, 31 gambling).

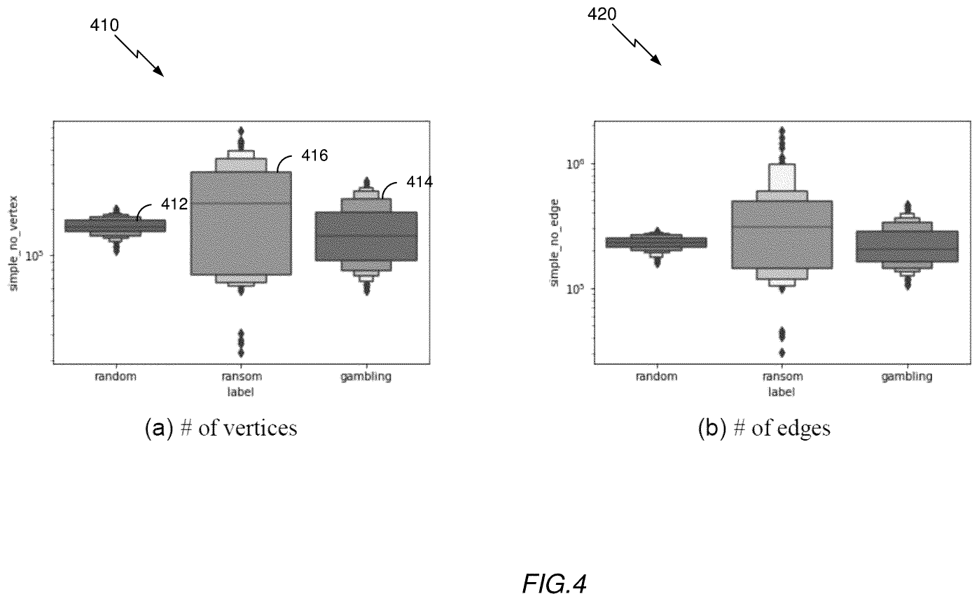

A brief review of the exploratory analysis on some of the features generated by the blocks 140 and 150 of FIG. 1 is now provided. Here, the ‘boxen plot’ (also referred to as box and whisker boxes) is used, which centers a distribution at its median line, with each successive level outward containing half of the remaining data until it reaches to the outlier level. For example, FIG. 4 includes boxen plots 410 and 420 showing the number of vertices and edges in the whole-simple Actor-to-Actor graphs. Recall that the whole graph is based on recursion of all connected transactions associated, for example, within two (2) days of the actor's activity. Thus, these graphs could be skinnier than the graphs over two days depending upon the level of connections of the actor. It can be seen that for ‘random’ and ‘gambling’ graphs (e.g., graphs 412 and 414 in the boxen plot 410), the distribution does not differ a lot. However, there are many extreme values in ‘ransom’ graphs (e.g., graph 416) and it is flatter compared to the other two. This reflects the nature of the ‘ransomware’ class where actors will try to obfuscate their transaction patterns through complicated laundering, which also reflects that the local clustering procedures/algorithms perform well.

For brevity, the rest of the analysis highlights only Ego-1-simple graphs for a few important features. The analysis looks at the marginal distribution of the selected features across all the actors separated by ransomware, random and gambling categories.

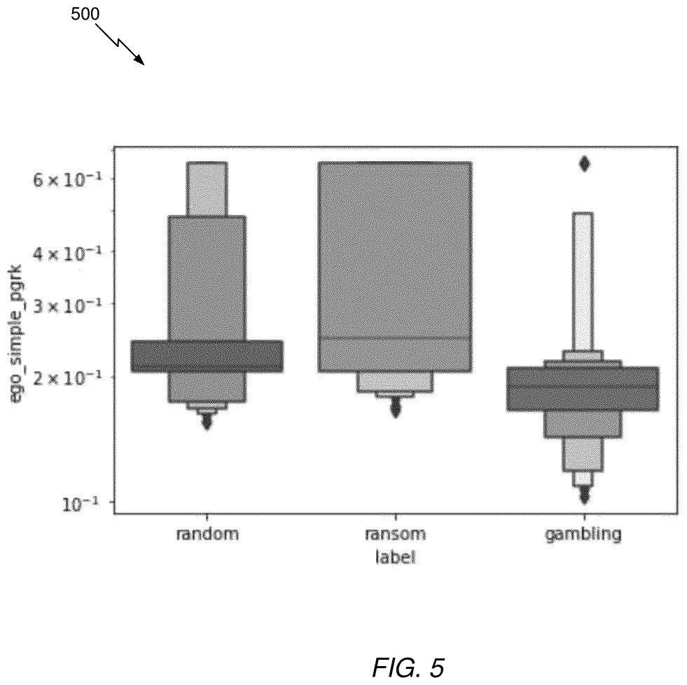

PageRank, also known as Google Rank, is a way of measuring the importance of website pages. The assumption is that more important websites are likely to receive more links from other websites. FIG. 5 includes boxen plots 500 for Page-Rank results obtained for the three classes considered (random, gambling, and random). As seen in FIG. 5, the ‘ransom’ clusters tend to have a higher PageRank, which means it is likely to receive more transactions from other clusters. This makes sense when the ransomware attack comprises one wave after another and usually involves lots of users (addresses) receiving communications triggered by the rogue actor within a short period of time. Also, PageRank of a random actor on average seems to be lower than ransomware actors, indicating that the ransomware actors are more often recipients of funds.

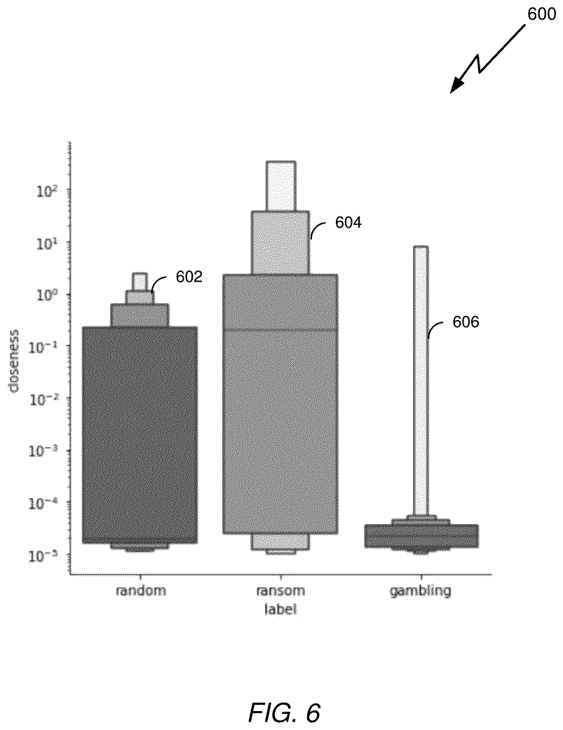

The closeness centrality of a vertex measures how easily other vertices can be reached from it (or the other way: how easily it can be reached from the other vertices). The weighted-IN closeness of ego-1 simple graphs 600 is shown in FIG. 6. The ‘gambling’ plot 606 tends to have less centrality than the ‘ransom’ and the ‘random’ classes (plots 604 and 602, respectively), which shows a similar pattern to that shown in FIG. 5. This suggests that gambling actors are not closely connected to other accounts. They have many more outliers indicating that there are few very large gamblers and possibly the distribution is scale-free.

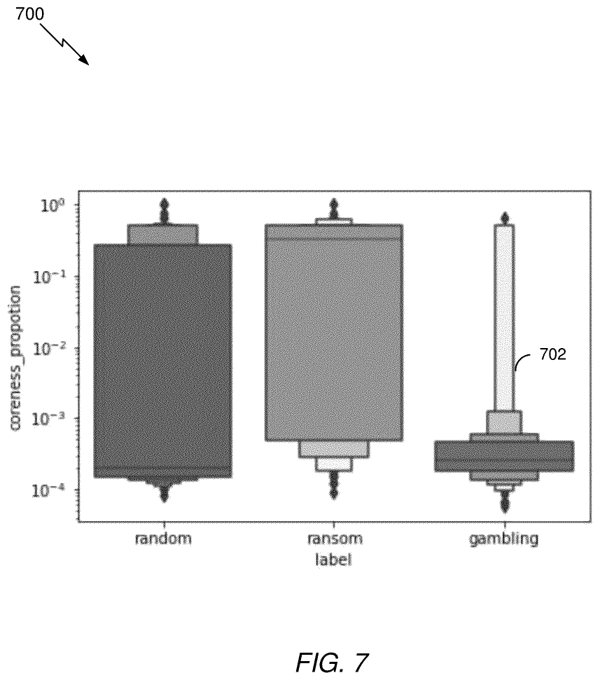

FIG. 7 includes plots 700 of the coreness parameter normalized by the number of vertices. The k-core of a graph is a maximal subgraph in which each vertex has at least degree k. The coreness of an Actor is k if it belongs to the k-core but not to the (k+1)-core. The coreness across a graph is normalized by the number of vertices since generally different graphs will have different number of vertices. As can be seen from FIG. 7 the gambling graph (as captured by plot 702) has a relatively low coreness.

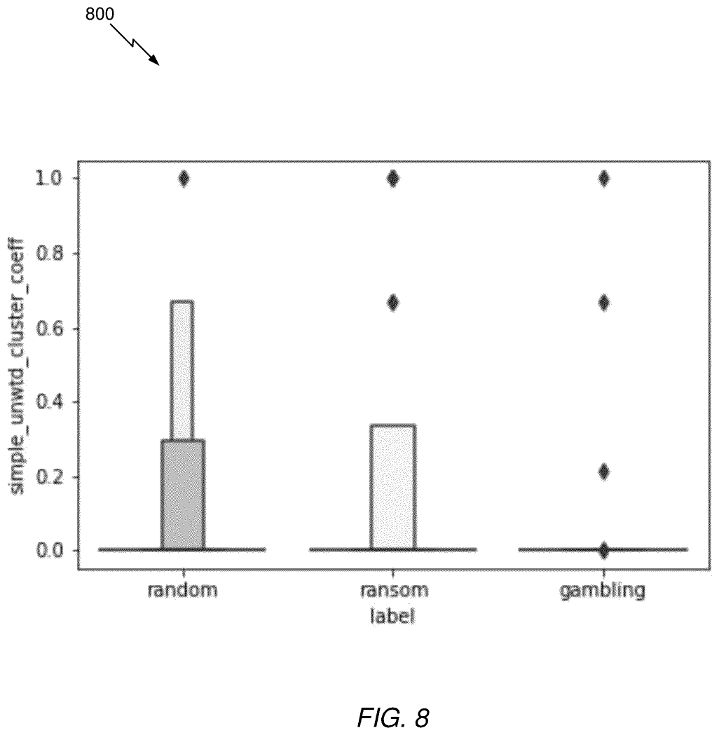

FIG. 8 includes plots 800 of the unweighted cluster coefficient, in the normal scale. As expected, FIG. 8 shows that cluster coefficients for gambling class are much smaller than the other classes, with ransomware being the next smallest class. Since both of those classes are directly involved in possibly criminal activities, actors would attempt to minimize their interactions with actors which are more connected with each other.

The comparative analysis of the marginal distributions of features discussed herein so far suggests that different classes behave differently from each other. For example, gambling actors behavior is rather different than other actors in closeness, PageRank, cluster-coefficient and coreness. Further, the PageRank of the ransomware actors is higher. This analysis indicates that these features could be good candidates for any machine learning model to identify ransomware actors and other actor classes based on the graphs (be it the transaction graphs, or the actor-to-actor graphs, and/or the subgraphs).

Thus, with continued reference to FIG. 1, once subgraphs and graph centrality features are determined, a classification process (implemented, in some examples, using machine learning) is applied, by the classification unit 160, to the extracted features (or to other types of data representative of the actor-to-actor graphs or to subgraphs) to determine if a particular actor/address is associated with a rogue actor.

During the testing and evaluation performed for the implementations of the proposed framework, for the purposes of supervised learning, the extracted whole graphs were divided into testing (20%) and training (80%) graphs stratified by their categories. Further, for each whole graph only the subgraphs of ego-graph 1, ego-graph 2, ego-graph 3 and their simple counterparts were extracted for analysis because of their proximity to the actor under consideration. Additionally, only subsets of features were extracted from each of these graphs. The subsets were obtained by keeping only one of each set of highly correlated features. The graphs and the corresponding number of features are shown in Table 1 below.

TABLE 1
Centrality Features Considered

| | ego3 | ego3- | ego2 | ego2- | ego1 | ego1- |
|---|---|---|---|---|---|---|
| # of features | 11 | 16 | 13 | 16 | 12 | 11 |

In the implementations of the proposed framework, supervised learning was considered in three stages, as shown in Table 2.

TABLE 2
Modeling Strategy/Stages

| Learning | Initial | Intermediate | Final |
|---|---|---|---|
| Type | Multiple Classifiers | Stacking | Bagging |

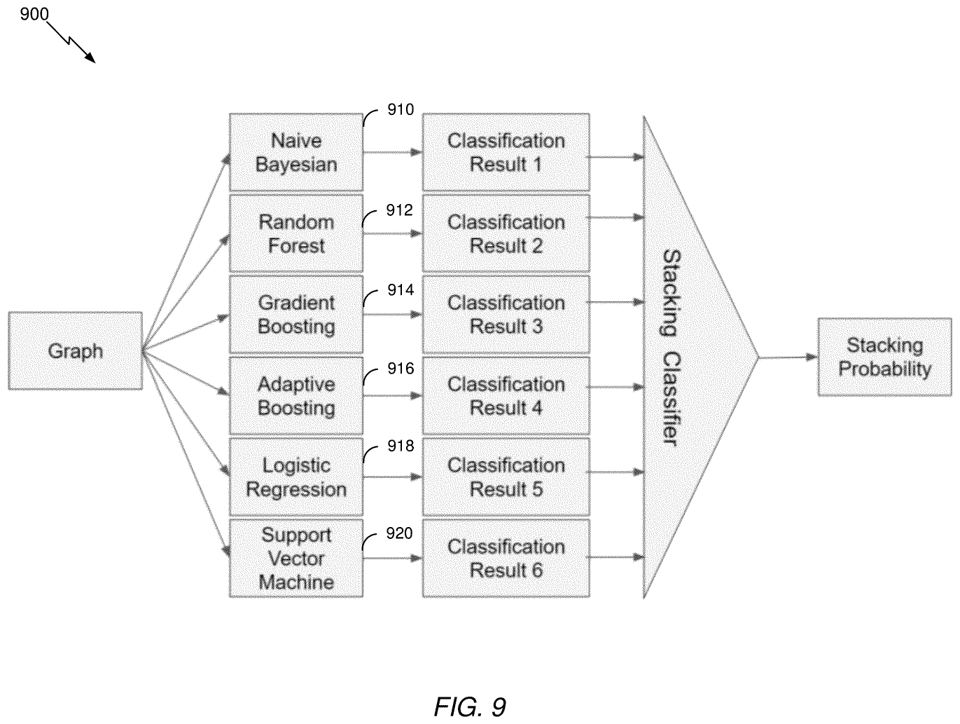

In some embodiments the Initial stage multiple classifiers were fitted to each of the 6 sub-graphs. Since each classifier has different strengths and weaknesses in different regions of the feature space, as an intermediate model an ensemble learning technique of Stacking was used to improve the classification process. Specifically, the stacked model used the predicted probabilities of each class by each classifier as features to predict the probability of each class by using a simple model. Even though there are three (3) classes, since the probabilities add up to 1 for each of the six classifiers, there are 12 such linearly independent features (if the classification required predicting more than 3 classes, there would be additional independent features that would need to be processed by the stacking classifier). This process is depicted in FIG. 9, which shows a diagram of a classifier stacking model with six different base classifiers (e.g., classifiers 910, 912, 914, 916, 918, and 920) used for creating a classification ensemble.

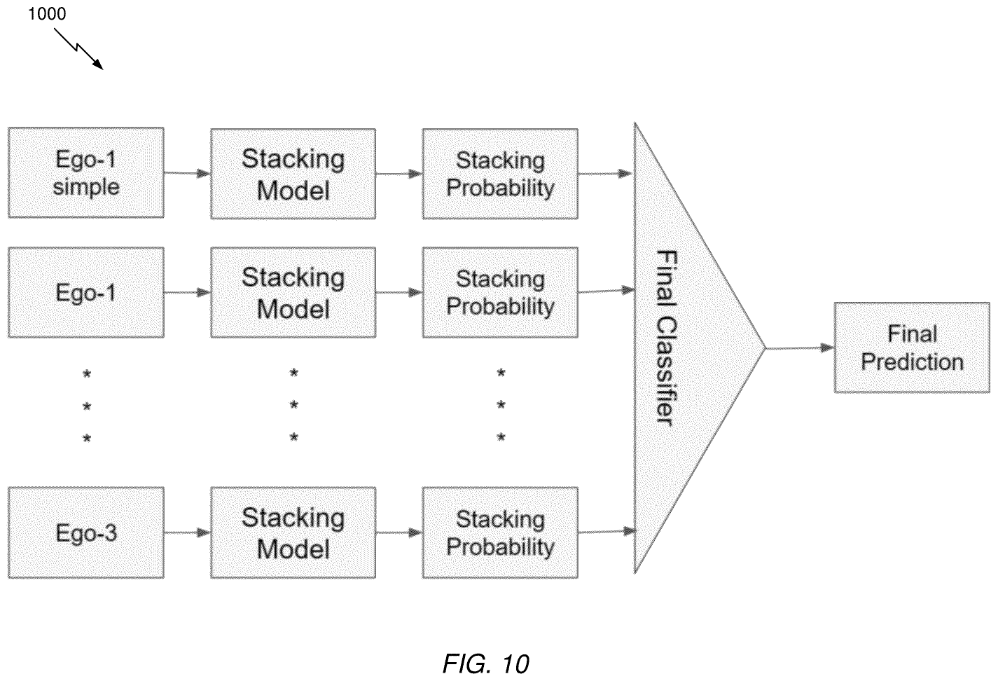

In the final Stacking-Bagging stage, the results across different subgraphs are combined by creating a meta classifier (also called Final Classifier). Such a classifier may be a simple classifier that uses the probabilities of each class in the subgraph stacked models as the feature set to fuse them into a single output. This is analogous to bagging since there are, in this example, six (6) different data sets (subgraphs) each containing estimated probabilities of each class. Just like in stacking, there are twelve (12) features for the six types of sub-graphs. The final attribution of the class is given to the class with highest probability by the meta-classifier. This process is depicted in FIG. 10, which provides a diagram of a stacking-bagging classification model 1000. As shown, in this example the predicted probabilities from six (6) graphs were used as new features and trained a final meta-classifier.

To appreciate the efficacy of the stacking-bagging model, consider the simple fusing procedure of averaging the probabilities across six (6) estimated probabilities for each data set. In that case, Mean Squared Error (MSE)=Bias\hat{ }2+Variance. Each component on the bias term is roughly the same constant since they are using the same type of estimators. The second term=average_variance/6+ΣCovariances/6. In the present example, since each estimated probability uses different graphs, it is expected that the covariances would be relatively negligible. Thus, the MSE will be substantially less compared to a non-fusing implementation. The cross-validation score was used on balanced-accuracy as an objective when running the model on the test set.

To implement the above outlined strategy, and to measure its efficacy, training data with cross validation for model selection was used. Specifically, when training the classifiers with grid-search and cross-validation, 5-folds were used with stratification on labels and 80% of the data for train-validation and 20% for testing. For the meta-classifier in the stacking model and for the stacking-bagging model, a Logistic Regression strategy was used.

Since the examples discussed above relate to a multi-label classification problem, balanced accuracy, weighted precision, and weighted recall were used as the evaluating metrics (these metrics can be referred to simply as accuracy, precision, and recall).

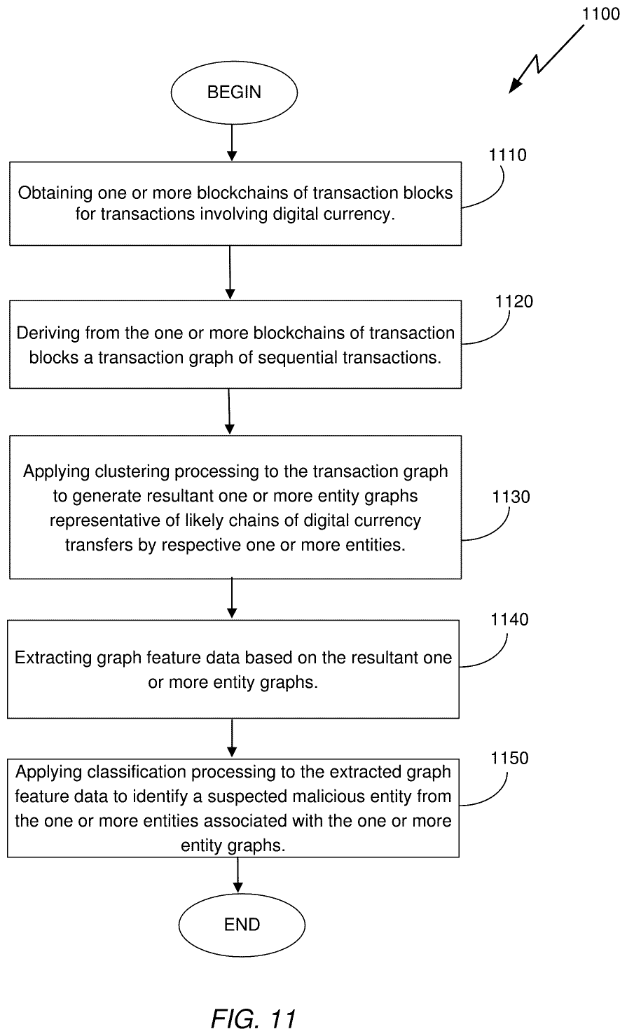

With reference next to FIG. 11, a flowchart of an example procedure 1100 for identifying illegal digital currency transactions is provided. The procedure 1100 includes obtaining 1110 one or more blockchains of transaction blocks for transactions involving digital currency, deriving 1120 from the one or more blockchains of transaction blocks a transaction graph of sequential transactions, and applying 1130 clustering processing to the transaction graph to generate resultant one or more entity graphs representative of likely chains of digital currency transfers by respective one or more entities.

In various examples, deriving the transaction graph of sequential transactions may include identifying a particular address associated with a particular transaction, and generating a restricted transaction graph from the transaction graph that extends n transaction blocks upstream and downstream from the identified particular transaction with the identified particular address. In such examples, the procedure may further include removing transaction blocks from the restricted transaction graph that are determined to be associated with addresses of gambling or exchange sites. The transaction graph may include transaction nodes in which a first transaction node specifies an output address associated with a second transaction node to which the first transaction node is connected.

In some embodiments, applying clustering processing to the transaction graph may include applying the clustering processing to local areas of the transaction graph. Applying clustering processing to the transaction graph may include applying localized and/or temporal clustering processing to form clusters according to set of rules applied to input and output addresses of each transaction node in the transaction graph.

With continued reference to FIG. 11, the procedure 1100 further includes extracting 1140 graph feature data based on the resultant one or more entity graphs, and applying classification processing 1150 to the extracted graph feature data to identify a suspected malicious entity from the one or more entities associated with the one or more entity graphs.

In some embodiments, extracting graph feature data may include determining from the one or more entity graphs one or more subgraphs, and computing for a subgraph, from the one or more determined subgraphs, one or more of graph centralities such as, for example, number of graph vertices, number of graph edges, total value of digital currency corresponding to the graph, number of graph loops, graph degree, graph neighborhood size, normalized closeness for one or more nodes of the graph, betweenness measure for the one or more nodes of the graph, a Page rank measure for the one or more nodes, cluster measure for the one or more nodes, coreness measure for the one or more nodes, and/or hub and authority measure for the one or more nodes. Determining the one or more subgraphs comprises determining at least one of, for example an ego graph and/or a simple graph.

In various examples, applying the classification processing may include applying a machine learning classification process to the extracted graph feature data to determine the suspected malicious entity. Applying the classification processing may include applying a machine learning classification process to data derived based on the one or more entity graphs, with the machine learning classification process being trained using initial address data comprising one or more digital currency addresses associated with one or more rogue transactions. In such examples, applying the machine learning classification process may include applying an ensemble of independent classification processes to the data derived based on the one or more entity graphs to separately determine, by the independent classification processes, respective classifications for one of the one or more entities, and determining a composite classification for the one or more entities based on the separate classifications determined by the independent classification processes. The transaction graph may include one or more starting nodes corresponding to the one or more digital currency addresses.

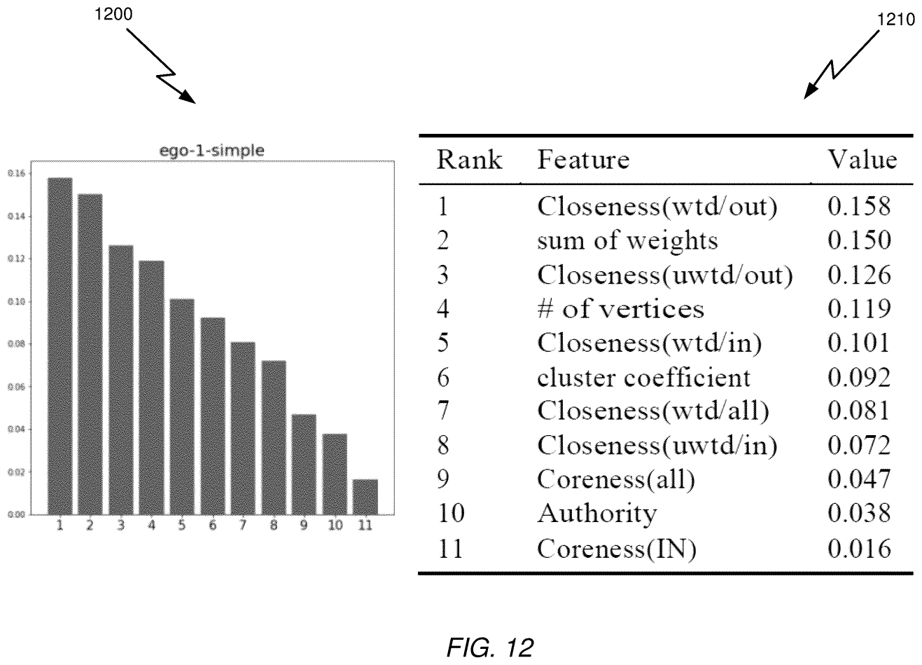

The performance of the proposed framework was tested and evaluated. FIG. 12 includes a graph 1200 showing feature importance for 11 features included in Random Forest model for an ego-1 simple graph. FIG. 12 also includes a table 1210 providing the values illustrated in the graph 1200. As shown in FIG. 12, the 11 features included in the Random Forest model for an ego-1 simple graph includes common centrality features, and also less frequently used features like coreness and cluster coefficient.

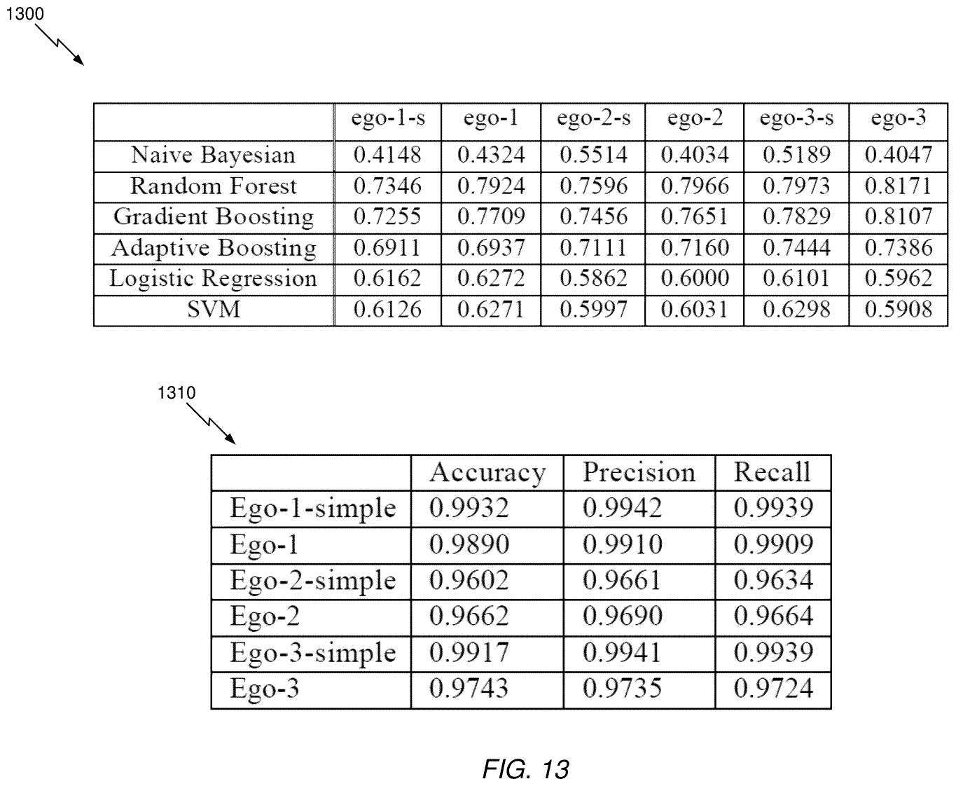

FIG. 13 includes a table 1300 showing the balanced accuracy of the different implemented classifiers for the various graphs. Stacking these models produces cross-validated balanced accuracy between 96% and 99% (a substantial improvement), as illustrated in the results listed in table 1310 of FIG. 13. It is interesting to note that ego-simple graphs tend to outperform their corresponding ego graphs.

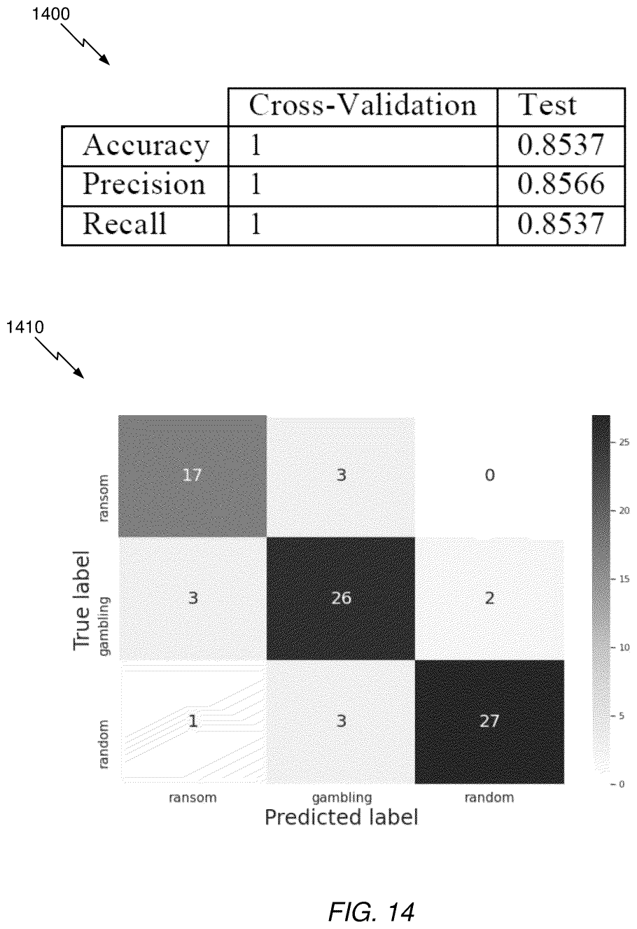

In the final stage, a bagging-stacking model is used on all six types of ego subgraphs leading to the cross-validated accuracy of 1 on the training set and 85% on the test set, as shown in table 1400 of FIG. 14. The figure also includes the corresponding confusion matrix 1410. As seen from the table 1400, the final model outperformed the stacking model as measured by cross-validated accuracy of 1. As seen from the confusion matrix 1410, there is no systematic confusion evident in the confusion matrix for the test set.

Performing the various techniques and operations described herein may be facilitated by a controller device (e.g., a processor-based computing device). Such a controller device may include a processor-based device such as a computing device, and so forth, that typically includes a central processor unit or a processing core. The device may also include one or more dedicated learning machines (e.g., neural networks) that may be part of the CPU or processing core. In addition to the CPU, the system includes main memory, cache memory and bus interface circuits. The controller device may include a mass storage element, such as a hard drive (solid state hard drive, or other types of hard drive), or flash drive associated with the computer system. The controller device may further include a keyboard, or keypad, or some other user input interface, and a monitor, e.g., an LCD (liquid crystal display) monitor, that may be placed where a user can access them.

The controller device is configured to facilitate, for example, identifying illegal digital currency transactions. The storage device may thus include a computer program product that when executed on the controller device (which, as noted, may be a processor-based device) causes the processor-based device to perform operations to facilitate the implementation of procedures and operations described herein. The controller device may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the controller device. Other modules that may be included with the controller device may include a user interface to provide or receive input and output data. The controller device may include an operating system.

In implementations based on learning machines, different types of learning architectures, configurations, and/or implementation approaches may be used. Examples of learning machines include neural networks, including convolutional neural network (CNN), feed-forward neural networks, recurrent neural networks (RNN), etc. Feed-forward networks include one or more layers of nodes (“neurons” or “learning elements”) with connections to one or more portions of the input data. In a feedforward network, the connectivity of the inputs and layers of nodes is such that input data and intermediate data propagate in a forward direction towards the network's output. There are typically no feedback loops or cycles in the configuration/structure of the feed-forward network. Convolutional layers allow a network to efficiently learn features by applying the same learned transformation(s) to subsections of the data. Other examples of learning engine approaches/architectures that may be used include generating an auto-encoder and using a dense layer of the network to correlate with probability for a future event through a support vector machine, constructing a regression or classification neural network model that indicates a specific output from data (based on training reflective of correlation between similar records and the output that is to be identified), etc.

The neural networks (and other network configurations and implementations for realizing the various procedures and operations described herein) can be implemented on any computing platform, including computing platforms that include one or more microprocessors, microcontrollers, and/or digital signal processors that provide processing functionality, as well as other computation and control functionality. The computing platform can include one or more CPU's, one or more graphics processing units (GPU's, such as NVIDIA GPU's, which can be programmed according to, for example, a CUDA C platform), and may also include special purpose logic circuitry, e.g., an FPGA (field programmable gate array), an ASIC (application-specific integrated circuit), a DSP processor, an accelerated processing unit (APU), an application processor, customized dedicated circuitry, etc., to implement, at least in part, the processes and functionality for the neural network, processes, and methods described herein. The computing platforms used to implement the neural networks typically also include memory for storing data and software instructions for executing programmed functionality within the device. Generally speaking, a computer accessible storage medium may include any non-transitory storage media accessible by a computer during use to provide instructions and/or data to the computer. For example, a computer accessible storage medium may include storage media such as magnetic or optical disks and semiconductor (solid-state) memories, DRAM, SRAM, etc.

The various learning processes implemented through use of the neural networks described herein may be configured or programmed using TensorFlow (an open-source software library used for machine learning applications such as neural networks). Other programming platforms that can be employed include keras (an open-source neural network library) building blocks, NumPy (an open-source programming library useful for realizing modules to process arrays) building blocks, etc.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A method for identifying illegal digital currency transactions, the method comprising:
obtaining one or more blockchains of transaction blocks for transactions involving digital currency;
deriving from the one or more blockchains of transaction blocks a transaction graph of sequential transactions;
applying clustering processing to the transaction graph to generate resultant one or more entity graphs representative of likely chains of digital currency transfers by respective one or more entities;
extracting graph feature data based on the resultant one or more entity graphs; and
applying classification processing to the extracted graph feature data to identify a suspected malicious entity from the one or more entities associated with the one or more entity graphs.

2. The method of claim 1, wherein applying the classification processing comprises:
applying a machine learning classification process to the extracted graph feature data to determine the suspected malicious entity.

3. The method of claim 1, wherein applying the classification processing comprises:
applying a machine learning classification process to data derived based on the one or more entity graphs;
wherein the machine learning classification process is trained using initial address data comprising one or more digital currency addresses associated with one or more rogue transactions.

4. The method of claim 3, wherein applying the machine learning classification process comprises:
applying an ensemble of independent classification processes to the data derived based on the one or more entity graphs to separately determine, by the independent classification processes, respective classifications for one of the one or more entities; and
determining a composite classification for the one or more entities based on the separate classifications determined by the independent classification processes.

5. The method of claim 3, wherein the transaction graph includes one or more starting nodes corresponding to the one or more digital currency addresses.

6. The method of claim 1, wherein extracting graph feature data comprises:
determining from the one or more entity graphs one or more subgraphs; and
computing for a subgraph, from the one or more determined subgraphs, one or more graph centralities, including one or more of: number of graph vertices, number of graph edges, total value of digital currency corresponding to the graph, number of graph loops, graph degree, graph neighborhood size, normalized closeness for one or more nodes of the graph, betweenness measure for the one or more nodes of the graph, a Page rank measure for the one or more nodes, cluster measure for the one or more nodes, coreness measure for the one or more nodes, or hub and authority measure for the one or more nodes.

7. The method of claim 6, wherein determining the one or more subgraphs comprises determining at least one of: an ego graph, or a simple graph.

8. The method of claim 1, wherein the transaction graph comprises transaction nodes in which a first transaction node specifies an output address associated with a second transaction node to which the first transaction node is connected.

9. The method of claim 1, wherein applying clustering processing to the transaction graph comprises applying the clustering processing to local areas of the transaction graph.

10. The method of claim 1, wherein applying clustering processing to the transaction graph comprises applying localized and/or temporal clustering processing to form clusters according to set of rules applied to input and output addresses of each transaction node in the transaction graph.

11. The method of claim 1, wherein deriving the transaction graph of sequential transactions comprises:
identifying a particular address associated with a particular transaction; and
generating a restricted transaction graph from the transaction graph that extends n transaction blocks upstream and downstream from the identified particular transaction with the identified particular address.

12. The method of claim 11, further comprising:
removing transaction blocks from the restricted transaction graph that are determined to be associated with addresses of gambling or exchange sites.

13. A system to identify illegal digital currency transactions comprising:
one or more memory devices to store processor-executable instructions and data; and
a processor-based controller, coupled to the one or more memory devices, configured, when executing the processor-executable instructions, to:
obtain one or more blockchains of transaction blocks for transactions involving digital currency;
derive from the one or more blockchains of transaction blocks a transaction graph of sequential transactions;
apply clustering processing to the transaction graph to generate resultant one or more entity graphs representative of likely chains of digital currency transfers by respective one or more entities;
extract graph feature data based on the resultant one or more entity graphs; and
apply classification processing to the extracted graph feature data to identify a suspected malicious entity from the one or more entities associated with the one or more entity graphs.

14. The system of claim 13, wherein the processor-based controller configured to apply the classification processing is configured to:
apply a machine learning classification process to the extracted graph feature data to determine the suspected malicious entity.

15. The system of claim 13, wherein the processor-based controller configured to apply the classification processing is configured to:
apply a machine learning classification process to data derived based on the one or more entity graphs;
wherein the machine learning classification process is trained using initial address data comprising one or more digital currency addresses associated with one or more rogue transactions.

16. The system of claim 15, wherein the processor-based controller configured to apply the machine learning classification process is configured to:
apply an ensemble of independent classification processes to the data derived based on the one or more entity graphs to separately determine, by the independent classification processes, respective classifications for one of the one or more entities; and
determine a composite classification for the one or more entities based on the separate classifications determined by the independent classification processes.

17. The system of claim 13, wherein the processor-based controller configured to extract graph feature data is configured to:
determine from the one or more entity graphs one or more subgraphs; and
compute for a subgraph, from the one or more determined subgraphs, one or more of graph centralities, including one or more of: number of graph vertices, number of graph edges, total value of digital currency corresponding to the graph, number of graph loops, graph degree, graph neighborhood size, normalized closeness for one or more nodes of the graph, betweenness measure for the one or more nodes of the graph, a Page rank measure for the one or more nodes, cluster measure for the one or more nodes, coreness measure for the one or more nodes, or hub and authority measure for the one or more nodes.

18. The system of claim 13, wherein the processor-based controller configured to apply the clustering processing to the transaction graph is configured to apply localized and/or temporal clustering processing to form clusters according to set of rules applied to input and output addresses of each transaction node in the transaction graph.

19. The system of claim 13, wherein the processor-based controller configured to derive the transaction graph of sequential transactions is configured to:
identify a particular address associated with a particular transaction; and
generate a restricted transaction graph from the transaction graph that extends n transaction blocks upstream and downstream from the identified particular transaction with the identified particular address.

20. A non-transitory computer readable media comprising computer instructions executable on a processor-based device to:
obtain one or more blockchains of transaction blocks for transactions involving digital currency;
derive from the one or more blockchains of transaction blocks a transaction graph of sequential transactions;
apply clustering processing to the transaction graph to generate resultant one or more entity graphs representative of likely chains of digital currency transfers by respective one or more entities;
extract graph feature data based on the resultant one or more entity graphs; and
apply classification processing to the extracted graph feature data to identify a suspected malicious entity from the one or more entities associated with the one or more entity graphs.
